(19) United States
(12) Patent Application Publication
(10) Pub. No.: US 2006/0142489 A1
(43) Pub. Date: Jun. 29, 2006

(54) Toughened polyamide for food packaging and health care applications

(76) Inventors: Richard T. Chou, Hockessin, DE (US); Barry A. Morris, Wilmington, DE (US); David D. Zhang, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/269,411

(22) Filed: Nov. 8, 2005

Related U.S. Application Data
(60) Provisional application No. 60/626,165, filed on Nov. 8, 2004.

(51) Int. Cl. C08L 77/00

(52) U.S. Cl. 525/178

(57) ABSTRACT

The present invention is a film or sheet comprising ethylene acid copolymer/polyamide blends that are useful for fabricating films, pouches and tubing for packaging. Films, pouches and tubing, obtained from compositions described herein are tough and demonstrate good mechanical properties and good optical properties, even at low temperature. More particularly, the compositions of ethylene copolymers and polyamides of the present invention can be used in packaging of foodstuffs and medical solutions.

This application claims the benefit of U.S. application Ser. No. 60/626,165, filed Nov. 8, 2004.

### BACKGROUND OF THE INVENTION

1. Field of the Invention

The present invention relates to compositions of polyamides and certain ethylene acid copolymers that are useful for fabricating monolayer or multilayer structures such as films, sheets, pouches, bottles and tubing with high optical clarity. More particularly, this invention relates to films and structures comprising nylon modified with an anhydride ionomer or blends of the anhydride ionomer and other polymers that provide excellent flex resistance, low temperature toughness, and most importantly retain good optical properties. The modified polyamide films and structures of this invention are suitable for food packaging and health care applications.

2. Description of the Related Art

Polyamides (nylon), and in particular nylon 6, are used widely for food packaging applications. Often the function of nylon is to provide mechanical strength and toughness. There is a need in industry to further improve the toughness of nylon films, especially at lower temperatures. For example, nylon 6-based multilayer films are used in packaging meat, which is often stored and transported at freezer temperatures. Under dry conditions and freezer temperatures, nylon tends to be brittle. Various means of moisturizing nylon to improve its low-temperature toughness have been practiced. These processes add undesirable complexity to the production of packaging films suitable for low-temperature storage of goods. Furthermore, it can be difficult to achieve reliable results, since processing, storage and handling conditions can affect the moisture content of the nylon film.

There are also approaches in toughening nylon with different polymeric modifiers with varied results. Adding typical modifiers that could bring about a desirable toughness and stiffness tend to reduce the optical clarity and can turn nylon 6 into an opaque film. Blends of nylon and modifiers typically consist of microscopic particles of one polymer dispersed in a continuous phase of the other polymer. Poorly dispersed and/or large particles tend to scatter rather than transmit light. As a result the polymer blends tend to be opaque. For example, maleated polyethylene can be used to modify nylon to provide toughness but sacrifices optical clarity. For many food packaging and health care applications, the see-through clarity and/or contact clarity of a film or structure, either monolayer or multilayer, are important.

Owing to their water-like clarity and high toughness, ionomers such as those available from DuPont under the trademark Surlyn® have also been used for modifying nylon. Ionomers are thermoplastic resins that contain metal ions in addition to organic-chain molecules. Ionomers have solid-state properties characteristic of cross-linked polymers and melt-fabricability properties characteristic of non-crosslinked thermoplastic polymers (see for example U.S. Pat. No. 3,264,272). As disclosed in U.S. Pat. No. 3,264,272, it is not essential that only one type of metal ion be employed in the formation of the ionomers, and more than one type of metal ion may be preferred in certain applications. Typically, commercially available ionomers such as Surlyn® are neutralized with a single metal ion, commonly zinc or sodium. However, the improvement in toughening polyamides is not fully satisfactory. Mixing of polyamides and ionomers such as those described in U.S. Pat. No. 3,317,631 usually leads to blends with good toughness, scratch resistance and other surface properties but with very poor optical properties (for example, opacity). Soft ionomers impart much improved toughness for nylon, but again the optical clarity is significantly sacrificed.

The means of overcoming the problem of toughening nylon described above are not free of shortcomings. The inherent difficulties in producing and maintaining high-moisture nylon films add significant cost or feasibility problems to the processor and/or end user. Use of polymer modifiers results in films of low clarity, significantly reducing their usefulness in packaging applications.

Recently a new family of ionomers has been disclosed in U.S. Pat. No. 5,700,890, wherein neutralized ethylene acid copolymers are prepared using dicarboxylic acids, or derivatives thereof, as monomers in addition to the monocarboxylic acids used in typical ionomers. These ionomers have been found to have better compatibility with polyamides than typical ionomers (see U.S. Pat. No. 5,859,137). These ionomeric copolymers may further contain an alkyl acrylate comonomer.

### SUMMARY OF THE INVENTION

We have found that nylon modified with a dicarboxylic acid derivative-containing ionomer, either by itself or in blends with other polymers such as conventional ionomers or maleic anhydride grafted ethylene copolymers, exhibits greatly improved toughness at low temperature, while retaining desirable optical clarity.

Accordingly, this invention provides a film obtained from a thermoplastic composition comprising:
(a) from about 65 to about 90 weight % of a polyamide; and
(b) from about 5 to about 35 weight % of a modifier comprising an ionomeric composition comprising a copolymer of
   (1) ethylene;
   (2) from about 5 weight % to about 15 weight % of an alpha, beta-unsaturated C₃-C₈ carboxylic acid;
   (3) from about 0.5 weight % to about 12 weight % of at least one comonomer that is an ethylenically unsaturated dicarboxylic acid or derivative thereof selected from the group consisting of maleic acid, fumaric acid, itaconic acid, maleic anhydride, and a C₁-C₄ alkyl half ester of maleic acid; and
   (4) from 0 weight % to about 30 weight % of monomers selected from alkyl acrylate and alkyl methacrylate, wherein the alkyl groups have from one to twelve carbon atoms;
      wherein (i) the carboxylic acid functionalities present are at least partially neutralized by one or more alkali metal, transition metal, or alkaline earth metal cations, (ii) the film held a temperature of less than −1 0° C. at least 50% of the time is capable of supporting a weight of at least about 165 grams dropped onto the film from a height of 66 cm above the film, and (iii) the film has a haze of less than about 4%, as determined according to ASTM D1003.

This invention also provides such an article wherein the modifier of component (2) further comprises at least one additional thermoplastic polymer in an amount up to about 30 weight % of the total thermoplastic composition.

The article may be in the form of a monolayer or multilayer film or sheet, pouch or bag, or tubing.

This invention also provides a package for containing a product comprising a monolayer or multilayer film or sheet comprising the compositions described above.

### DETAILED DESCRIPTION OF THE INVENTION

All references disclosed herein are incorporated by reference.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present).

“Copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

Thermoplastic resins are polymeric materials that can flow when heated under pressure. Melt index (Ml) is the mass rate of flow of a polymer through a specified capillary under controlled conditions of temperature and pressure. It is typically measured according to ASTM 1238.

This invention provides a polymeric blend that is a marriage of a polyamide such as nylon 6 and an ionomer selected from a special family of ionomers (denoted anhydride ionomers or anhydride Surlyn®) to provide new materials that are highly suitable for applications requiring high optical clarity and low temperature toughness. In essence, the new materials overcome some of the major deficiencies of both polyamides and ionomers, while continuing to retain most of the desirable attributes. As indicated above, the ionomers used in this invention are selected from a family of ionomers containing dicarboxylic acid moieties, or derivatives thereof. As used herein, the term “anhydride ionomer” can be used to describe an ionomer of the present invention that includes dicarboxylic acid moieties, derivatives thereof such as anhydrides or other known carboxylic acid derivatives. The presence of dicarboxylic acid moieties in the ionomers enhances the compatibility with polyamides, particularly at higher levels, and provides blends with very good transparency. Higher amounts of dicarboxylic acid moieties provide two unique features to blends of such ionomers and a polyamide, such as nylon 6. First, the anhydride ionomer is dispersed in the polyamide in extremely fine particles and second, the particle size distribution is very narrow.

As indicated above, this invention provides an article of high optical clarity comprising a thermoplastic composition: the composition comprising (i) a polyamide, (ii) an ionomeric composition comprising a copolymer of ethylene, (iii) an alpha,beta-unsaturated C₃-C₈ carboxylic acid, (iv) at least one comonomer that is an ethylenically unsaturated dicarboxylic acid or derivative thereof, and (v) optionally at least one comonomer selected from alkyl acrylate and alkyl methacrylate. Ionomeric resins (“ionomers”) are ionic copolymers of an olefin such as ethylene (E) with a metal salt of an unsaturated carboxylic acid, such as acrylic acid (AA), methacrylic acid (MAA), and/or other acids, and optionally softening comonomers. At least one alkali metal, transition metal, or alkaline earth metal cation, such as lithium, sodium, potassium, magnesium, calcium, or zinc, or a combination of such cations, is used to neutralize some portion of the acidic groups in the copolymer resulting in a thermoplastic resin exhibiting enhanced properties. For example, a copolymer of ethylene and acrylic acid can then be at least partially neutralized by one or more alkali metal, transition metal, or alkaline earth metal cations to form an ionomer. Copolymers can also be made from an olefin such as ethylene, an unsaturated carboxylic acid and other comonomers such as alkyl (meth)acrylates providing “softer” resins that can be neutralized to form softer ionomers.

The ionomers useful in this invention consist of a family of ionomers containing dicarboxylic acid moieties that can be derived from ethylenically unsaturated derivatives of dicarboxylic acid comonomers, such as maleic anhydride and ethyl hydrogen maleate, at least partially neutralized by one or more alkali metal, transition metal, or alkaline earth metal cations (denoted as anhydride ionomers). They are copolymers of ethylene, an α,β-unsaturated C₃-C₈ carboxylic acid and at least one comonomer that is an ethylenically unsaturated dicarboxylic acid at an amount of from about 0.5 weight % to about 12 weight %, alternatively from about 3 weight % to about 12 weight %. Preferably, the dicarboxylic acid comonomer(s) are present in an amount from about 4 weight % to about 10 weight %. The unsaturated dicarboxylic acid comonomers or their derivatives can be selected from, for example, maleic anhydride (MAH), ethyl hydrogen maleate (also known as maleic acid monoethylester—MAME), and itaconic acid (ITA). More preferably, a composition of the present invention comprises from 4 to 8 weight % of maleic acid monomethylester comonomer in an ethylene/methacrylic acid/maleic acid monomethylester copolymer wherein the acid groups in said copolymer are from 20 to 70 percent neutralized.

Some non-neutralized ethylene acid copolymers comprising lower amounts of ethylenically unsaturated dicarboxylic acid comonomers are known (see U.S. Pat. No. 5,902,869), as are their ionomeric derivatives (see U.S. Pat. No. 5,700,890).

As indicated above, comonomers such as alkyl (meth)acrylates can be included in the ethylene acid copolymer to form a copolymer ionomer that can be neutralized with alkali metal, alkaline earth metal or transition metal cations. Preferred are comonomers selected from alkyl acrylate and alkyl methacrylate wherein the alkyl groups have from 1 to 8 carbon atoms, and more preferred are comonomers selected from methyl acrylate, ethyl acrylate, iso-butyl acrylate (iBA), and n-butyl acrylate (nBA). The alkyl (meth)acrylates are optionally included in amounts from 0 to about 30 weight % alkyl (meth)acrylate and preferably from 0 to about 15 weight %.

Examples of copolymers useful in this invention include copolymers of ethylene, methacrylic acid and ethyl hydrogen maleate (E/MAA/MAME) and copolymers of ethylene, acrylic acid and maleic anhydride (E/AA/MAH).

Neutralization of an ethylene acid copolymer can be effected by first making the ethylene acid copolymer and treating the copolymer with inorganic base(s) with alkali metal, alkaline earth metal or transition metal cation(s). The copolymer can be from about 10 to about 99.5% neutralized with at least one metal ion selected from lithium, sodium, potassium, magnesium, calcium, barium, lead, tin, zinc, aluminum; or combinations of such cations. Typically, neutralization will be from about 10 to about 70%. Preferably the copolymer has from about 20%, alternatively from about 35%, to about 70% of the available carboxylic acid groups ionized by neutralization with at least one metal ion selected from sodium, zinc, lithium, magnesium, and calcium; and more preferably zinc or magnesium., Of particular note are ionomers comprising zinc as a neutralizing cation. Also of note are copolymers wherein the acid groups are neutralized with a combination of zinc and magnesium ions. Methods for preparing ionomers from copolymers are well known in the art.

Polyamides used in the present invention are well known to those skilled in the art. Polyamides suitable for this invention are generally prepared from lactams or amino acids (e.g. nylon 6 or nylon 11), or prepared from condensation of diamines such as hexamethylene diamine with dibasic acids such as succinic, adipic, or sebacic acid. Copolymers and terpolymers of these polyamides are also included. Preferred polyamides useful in the present invention include polyepsiloncaprolactam (nylon 6); polyhexamethylene adipamide (nylon 6,6); nylon 11; nylon 12, nylon 12,12 and copolymers and terpolymers such as nylon 6/6,6; nylon 6,10; nylon 6,12; nylon 6,6/12; nylon 6/6,6/6,10 and nylon 6/6T. More preferred polyamides are polyepsiloncaprolactam (nylon 6), polyhexamethylene adipamide (nylon 6,6), and most preferred is nylon 6. Although these polyamides described above are the preferred polyamides, other polyamides such as amorphous polyamides are not explicitly excluded.

The compositions used in the present invention can optionally further comprise additional thermoplastic materials blended with the anhydride ionomer of component (2). Blending additional components allows one to more easily modify the properties of a composition of this invention by manipulating the amount and type of additional components present in the composition in addition to varying the percentages of the monomers in the ethylene acid copolymer. Furthermore, blending additional thermoplastic materials can allow for easier, lower cost manufacture of polymer compositions by allowing one to prepare fewer base resins that can be subsequently modified to obtain desired properties. For example, blends of anhydride ionomers with additional thermoplastic materials may be used in polyamide modifier compositions to provide a combination of both higher clarity and higher toughness than can be achieved by a modifier composition comprising a single material. Accordingly, this invention also provides articles wherein the modifier of component (2) further comprises a second thermoplastic polymer in an amount up to about 30 weight % of the total thermoplastic composition in combination with the anhydride ionomer.

Examples of other thermoplastic materials that can be used in addition to the anhydride ionomer include nonionomeric thermoplastic copolymers and/or ionomeric thermoplastic copolymers. The additional nonionomeric thermoplastic polymer components can be selected from among maleated polymers, copolyetheresters, copolyetheramides, elastomeric polyolefins, styrene diene block copolymers, thermoplastic polyurethanes, etc., these classes of polymers being well known in the art (see below for more detailed descriptions of these materials). Preferred polymers include conventional ionomers (i.e. ionomers that do not comprise a dicarboxylic comonomer), particularly soft ionomers, or maleated polymers, particularly maleic anhydride grafted ethylene copolymers.

Of particular note are blends of component (1) and component (2) further comprising conventional ionomers. Accordingly, compositions of this invention include blends of component (1) with component (2) further comprising (in combination with the anhydride ionomer) one or more E/X/Y copolymers where E is ethylene, X is a C₃ to C₈ α,β-ethylenically unsaturated carboxylic acid, and Y is a comonomer selected from alkyl acrylate and alkyl methacrylate wherein the alkyl groups have from 1 to 8 carbon atoms, wherein X is present in from about 2 to about 30 weight % of the E/X/Y copolymer, Y is present from 0 to about 40 weight % of the E/X/Y copolymer, wherein the carboxylic acid functionalities present are at least partially neutralized by one or more alkali metal, transition metal, or alkaline earth metal cations. Preferred α,β-ethylenically unsaturated carboxylic acids include acrylic acid and methacrylic acid. Non-limiting, illustrative examples of conventional ionomers include E/15MAA/Na, E/19MAA/Na, E/15AA/Na, E/19AA/Na, E/15MAA/Mg, E/19MAA/Li, and E/1 5MAA/60Zn (wherein E represents ethylene, MM represents methacrylic acid, M represents acrylic acid, the numbers represents either the weight % of comonomer(s) present in the copolymer or the amount of neutralization of the available carboxylic acid groups, and the atomic symbol represents the neutralizing cation). Of particular note are soft conventional ionomers comprising at least one alkyl acrylate or alkyl methacrylate comonomer, such as for example, E/9MAA/10iBA/70Zn and E/9MAA/23nBA/50Zn.

Depending on the need of a particular application, the amount of such conventional ionomer or mixture of conventional ionomers in combination with the anhydride ionomer in component (2) can be manipulated to provide an appropriate balance of clarity, toughness and low temperature impact strength. For example, highly toughened polyamide compositions with improved clarity can be achieved by using relatively larger amounts of conventional ionomers with smaller amounts of anhydride ionomers (for example, 30 weight % of a conventional ionomer and 5 weight % of anhydride ionomer). High-clarity toughened polyamide films can be prepared using relatively larger amounts of anhydride ionomers with smaller amounts of conventional ionomers (for example, 30 weight % of anhydride ionomer and 5 weight % of a conventional ionomer). Of note are modifier blends comprising equal amounts of anhydride ionomer and conventional ionomer (for example, 15 weight % of anhydride ionomer and 15 weight % of a conventional ionomer).

Also of particular note are blends further comprising maleic anhydride-grafted polymers (maleated polymers). Maleic anhydride-grafted polymers include maleated polyethylene, maleated polypropylene, maleated polyethylene/polypropylene rubber, maleated styrene-ethylene-butene-styrene triblock copolymer, and maleated polybutadiene. Additional details on the preparation and use of maleated polyethylenes are described in U.S. Pat. No. 6,545,091. An example of a maleic anhydride modified linear high-density polyethylene is a product sold under the trademark Polybond® 3009 available from Crompton Corporation. Similar maleated polyolefins are sold under the trademark Fusabond® available from DuPont. Preferred maleated polyethylenes include those with densities less than 0.90 g/cm³. These lower-density maleated polyethylenes are considered to be “softer” modifiers.

Depending on the need of a particular application, the amount of such maleated polymer(s) in combination with the anhydride ionomer in component (2) can be manipulated to provide an appropriate balance of clarity, toughness and low temperature impact strength. For example, highly toughened polyamide compositions with improved clarity can be achieved by using relatively larger amounts of maleated polymers with smaller amounts of anhydride ionomers (for example, 30 weight % of a maleated polymer and 5 weight % of anhydride ionomer). High-clarity toughened polyamide films can be prepared using relatively larger amounts of anhydride ionomers with smaller amounts of maleated polymers (for example, 30 weight % of anhydride ionomer and 5 weight % of a maleated polymer). Of note are modifier blends comprising equal amounts of anhydride ionomer and maleated polymers (for example, 15 weight % of anhydride ionomer and 15 weight % of a maleated polymer).

The compositions of the present invention can additionally comprise optional materials, such as conventional additives used in polymeric materials including: plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, and/or mixtures thereof. These conventional ingredients may be present in the compositions according to this invention, from 0.01 to 20 weight %, preferably from 0.1 to 15 weight %. When present, the amount of these conventional additives is in addition to the weight % of the components of the composition as defined in the Summary.

The compositions of the present invention can be formed into articles by various means known to those skilled in the art. For example, the compositions of this invention can be (co)extruded and formed into a film by various film-forming means or profile-extruded to form tubing. A sheet comprising the toughened compositions could be further processed by thermoforming into a shaped article. For example, a sheet comprising a toughened polyamide composition as described herein could be formed into a shaped piece that could be included in packaging. Films of this invention can be used as web stock to be formed into pouches of this invention. Pouches are formed from web stock by either cutting and heat sealing separate pieces of web stock and/or by a combination of folding and heat sealing with cutting. Bottles can be made via (co)extrusion blow molding. Examples of articles of this invention comprising a composition as described herein include films and pouches used as packaging for meat and other foodstuffs; pouches and bottles used for containing and dispensing health care solutions or other fluids; and tubing for transferring health care solutions or other fluids.

Articles of this invention comprising compositions comprising the ethylene acid copolymer-polyamide blends may further comprise other components. For example, compositions of this invention may be included as one or more layers of a multilayer polymeric structure in which additional layers of thermoplastic resins may be included to provide functional layers to provide additional functionality to the article. Of note are multilayer structures comprising ionomeric materials in at least one additional layer. The layer(s) of the composition of this invention and other polymeric layers may be formed independently and then adhesively attached to one another to form an article of this invention. The article of this invention may also be fabricated by extrusion coating or laminating some or all of the layers onto a substrate. Some of the components of an article of this invention may be formed together by coextrusion, particularly if the components are relatively coplanar. Thus, an article of this invention may be a film or sheet comprising a layer of the composition of this invention and one or more additional layers of different thermoplastic material(s) in a multilayer coextruded film or sheet.

Examples of other thermoplastic materials that can be used to form a component of an article in addition to a component formed from the compositions of the present invention in multicomponent or multilayer structures (e.g. films or sheets) can be selected from nonionomeric thermoplastic copolymers and/or conventional ionomeric thermoplastic copolymers.

Nonionic thermoplastic resins include, by way of non-limiting illustrative examples, thermoplastic elastomers, such as polyurethane, poly-ether-ester, poly-amide-ether, polyether-urea, PEBAX (a family of block copolymers based on polyether-block-amide, commercially supplied by Atochem), styrene-butadiene-styrene (SBS) block copolymers, styrene(ethylene-butylene)-styrene block copolymers, etc., polyamide (oligomeric and polymeric), polyesters, polyolefins including polyethylene, polypropylene, ethylene/propylene copolymers, etc., ethylene copolymers with various comonomers, such as vinyl acetate, (meth)acrylates, (meth)acrylic acid, epoxy-functionalized monomer, CO, etc., functionalized polymers with maleic anhydride, epoxidization etc., either by copolymerization or by grafting, elastomers such as EPDM, metallocene catalyzed PE and copolymer, ground up powders of the thermoset elastomers, etc.

The additional thermoplastic polymer components can be selected from among copolyetheresters, copolyetheramides, elastomeric polyolefins, styrene diene block copolymers, thermoplastic polyurethanes, etc., these classes of polymers being well known in the art.

Copolyetheresters are discussed in detail in patents such as U.S. Pat. Nos. 3,651,014; 3,766,146; and 3,763,109. Preferred copolyetherester polymers are those where the polyether segment is obtained by polymerization of tetrahydrofuran and the polyester segment is obtained by polymerization of tetramethylene glycol and phthalic acid. The more polyether units that are incorporated into the copolyetherester, the softer the polymer.

The copolyetheramides are also well known in the art as described in U.S. Pat. No. 4,331,786, for example. They are comprised of a linear and regular chain of rigid polyamide segments and flexible polyether segments.

The elastomeric polyolefins are polymers composed of ethylene and higher primary olefins such as propylene, hexene, octene and optionally 1,4-hexadiene and or ethylidene norbornene or norbornadiene. The elastomeric polyolefins can be functionalized with maleic anhydride.

Thermoplastic polyurethanes are linear or slightly chain-branched polymers consisting of hard blocks and soft elastomeric blocks. They are produced by reacting soft hydroxy-terminated elastomeric polyethers or polyesters with diisocyanates such as methylene diisocyanate (MDI) or toluene diisocyanate (TDI). These polymers can be chain extended with glycols, diamines, diacids, or aminoalcohols. The reaction products of the isocyanates and the alcohols are called urethanes and these blocks are relatively hard and high-melting. These hard, high-melting blocks are responsible for the thermoplastic nature of the polyurethanes.

Block styrene diene copolymers are composed of polystyrene units and polydiene units. The polydiene units are derived from polybutadiene, polyisoprene units or copolymers of these two. In the case of the copolymer it is possible to hydrogenate the polyolefin to give saturated rubbery backbone segments. These materials are usually referred to as SBS, SIS or SEBS thermoplastic elastomers and they can also be functionalized with maleic anhydride.

Conventional ionomers are described above.

This invention relates to blown films, cast films, laminated films, extrusion blow molding, tubing, pouches and the like prepared from compositions described above. The term “sheets” may be used interchangeably to describe processed compositions of the present invention. The processing method and/or the thickness may influence whether the term “sheet” or “film” is used herein, but for the purposes of the present invention, either term can be used herein to describe the presently claimed invention.

A laminate film of the present invention can be prepared by coextrusion as follows: granulates of the various components are melted in extruders. The molten polymers are passed through a die or set of dies to form layers of molten polymers that are processed as a laminar flow. The molten polymers are cooled to form a layered structure. Molten extruded polymers can be converted into a film using a suitable converting technique. For example, a film of the present invention can also be made by coextrusion followed by lamination onto one or more other layers. Other suitable converting techniques are, for example, blown film extrusion, cast film extrusion, cast sheet extrusion and extrusion coating.

A film of the present invention can be further oriented beyond the immediate quenching or casting of the film. The process comprises the steps of (co)extruding a laminar flow of molten polymers, quenching the (co)extrudate and orienting the quenched (co)extrudate in at least one direction. The film may be uniaxially oriented, or it can be biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. Examples of such apparatus and processes include, for example, those disclosed in U.S. Pat. Nos. 3,278,663; 3,337,665; 3,456,044; 4,590,106; 4,760,116; 4,769,421; 4,797,235 and 4,886,634.

In an embodiment of the present invention, a film of the present invention is oriented using a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which will induce longitudinal orientation.

The processing to obtain an oriented blown film is known in the art as a double bubble technique, and can be carried out as described by Pahlke in U.S. Pat. No. 3,456,044. More particularly, a primary tube is melt extruded from an annular die. This extruded primary tube is cooled quickly to minimize crystallization and then collapsed. It is then heated to its orientation temperature (for example, by means of a water bath). In the orientation zone of the film fabrication machine a secondary tube is formed by inflation, thereby the film is radially expanded in the transverse direction and pulled or stretched in the machine direction at a temperature such that expansion occurs in both directions, preferably simultaneously; the expansion of the tubing being accompanied by a sharp, sudden reduction of thickness at the draw point. The tubular film is then again flattened through nip rolls. The film can be reinflated and passed through an annealing step (thermofixation), during which step it is heated once more to adjust the shrink properties. In some applications, it may be desirable to maintain the film in a tubular form. For preparing flat films the tubular film can be slit along its length and opened up into flat sheets that can be rolled and/or further processed.

A film obtained from a composition described herein can be used in various combinations with other film layers to form a multilayer film or as a monolayer film. Examples of multilayer structures of this invention, particularly in the form of films, include (from outermost to innermost product-contact layer of the film):
Modified polyamide/tie/sealant;
Modified polyamide/tie/EVOH/tie/sealant; and
Modified polyamide/tie/EVOH/modified polyamide/tie/bulking layer-sealant.

The modified polyamide in these structures provides abuse resistance, temperature resistance (during heat sealing), barrier, puncture resistance, thermoformability, and/or a printable surface. EVOH may be included as an additional barrier layer. The sealant can be a variety of polymers, but is preferably polyethylene, ethylene/vinyl acetate copolymer or an ionomer. These are suitable for packaging a wide variety of food and other items such as medical devices.

Some of the films or sheets described above can be used as forming webs in thermoforming operations to provide shaped articles for packaging. Films of the present invention can be thermoformed at temperatures that are typically lower than the glass transition temperatures of polyamides not of the present invention. This can advantageously allow for thermoforming articles having components that cannot withstand the higher temperatures typically required for polyamides not of the present invention. Polyamides of the present invention can be thermoformed at temperatures within the range of from about 100° C. to about 180° C. Typically the thermoformed articles are shaped to conform to the shape of the product that is contained within the package. Thermoformed packages can be used to contain processed meats such as hot dogs, sausages and the like.

Another example multilayer film structure is:
polyethylene/tie/modified polyamide/tie/polyethylene.

This film is useful as a chub film for meat packaging and shrink films.

This invention also provides a package for containing a product comprising a monolayer or multilayer film or sheet comprising the compositions described above. Preferred packages and packages of note comprise preferred compositions and compositions of note described above. Packages of this invention are useful for packaging meat and other foodstuffs that are stored at low temperatures.

Packages of this invention also include those comprising monolayer or multilayer films that are suitable for the packaging, dispensing and/or administration of fluids such as beverages or medical solutions. This invention also relates to pouches and/or bottles, and particularly pouches and/or bottles for storing and transferring medical solutions, comprising the compositions and multilayer structures described above. As used herein, the terms “bottles” and “pouches” can be used interchangeably to refer to containers for dispensing and/or administration of fluids.

Currently, it is common practice to supply medical fluids or solutions for parenteral—for example, intravenous (or IV)—administration in the form of disposable, flexible pouches. One class of such pouches is commonly referred to as an “IV bag.” These pouches must meet a number of performance criteria, including collapsibility, optical clarity and transparency, high-temperature heat-resistance (steam sterilizable), and sufficient mechanical strength to withstand the rigors of the use environment. Medical solution pouches must also provide a sufficient barrier to the passage of moisture vapor and other gases to prevent oxidation and concentration changes of the solution contained therein.

Collapsibility is necessary in order to ensure proper and complete drainage of the pouch. As the pouch drains, atmospheric pressure collapses the pouch at a rate that is proportional to the rate of drainage. In this manner, the pouch can be fully drained and at a substantially constant rate. Consequently, the film from which the pouch is made must be sufficiently flexible so that the resultant medical pouch is collapsible.

Optical clarity and transparency is important to allow for a visual inspection of the solution contained within the pouch to provide a cursory determination that the medical solution to be administered is of the proper type and has not deteriorated or become contaminated. As will be discussed more fully below, the industry-wide practice of heat-sterilizing solution-containing medical pouches greatly exacerbates the problem of maintaining good optical properties in such pouches.

High-temperature heat-resistance of the film can be desirable because it allows for heat-sterilization of solution-containing medical pouches. Heat sterilization typically occurs in steam-heated autoclaves at about 116 to 130° C. (240 to 266° F.) for periods of 15 to 30 minutes. The manufacturer and/or packager of the medical solution normally will perform heat-sterilization before sending the packaged medical solution to the end user, e.g., a hospital. This helps to ensure that the medical solution, as packaged in the medical solution pouch, will be substantially free from contamination.

In some cases, medical fluids in pouches are stored at low temperatures and, consequently, the pouch must also have sufficient low-temperature toughness. Low temperature, as the term is used herein, refers to a temperature of less than about 0 ° C., or preferably less than −5° C. Even more preferably, low temperature refers to a temperature of less than −1 5° C. Low temperature toughness can be measured by conducting testing the film for brittleness, or lack thereof, at low temperature. One test that is a measure of toughness that can be instructive is the Dart Impact test, wherein a weight is dropped onto a suspended film and the result observed and recorded. Acceptable Dart Impact for a film of the present invention is observed when a 50% failure rate is observed at or above 165 grams, preferably 50% failure is observed at or above 250 grams, more preferably 50% failure is observed at or above 350 grams, and even more preferably at or above 500 grams, at a temperature of −10° C. The toughness of a film can be affected by the thickness of the film, and therefore the Dart Impact results should be interpreted and compared relative to films of similar thickness.

Medical solution pouches must also have sufficient mechanical strength to withstand the abuse that is typically encountered in the use environment. For example, in some circumstances, a plastic or rubber bladder is placed around a medical solution-containing pouch and pressurized up to about 400 mm of Hg, e.g., 300-400 mm of Hg, in order to force the solution out of the pouch an into a patient. Such a bladder is commonly referred to as a “pressure-cuff” and is used, e.g., when a patient is bleeding profusely in order to quickly replace lost fluids or, e.g., when a patient has high blood pressure such that a greater opposing pressure must be generated in the pouch in order to introduce medical solution into the patient's veins. Medical solution pouches should have sufficient durability to remain leak-free during such procedures.

When used to form medical solution pouches, the multilayer films of the present invention possess excellent optical properties (i.e., transmission, clarity, and haze) after the medical solution-containing pouches have been heat-sterilized as described above.

In addition to providing excellent optical properties, the multilayer films of the present invention exhibit all of the other performance criteria that are required in a medical solution pouch. That is, the multilayer films have good flexibility/collapsibility and mechanical strength, and are able to withstand high-temperature sterilization. In addition, the films provide good barrier properties. For these reasons, the multilayer films of this invention are ideally suited for preparing pouches for the packaging and administration of medical solutions. Examples of medical solutions that are packaged and administered in this manner include saline solutions, dextrose solutions, and solutions for dialysis applications. However, the films and pouches of this invention could also be used in any other application wherein tough, high-clarity films or pouches are needed. For example, biological fluids such as blood and blood products, fermentation broths, biopharmaceuticals and the like may also be stored in pouches of this invention.

Other fluids that can be packaged in pouches of this invention include beverages. The beverage can be any liquid for drinking, such as water, fruit or vegetable juices or juice drinks, soy-based products, dairy products, other flavored drinks and the like, optionally including additional ingredients such as nutrients, electrolytes, vitamins, fiber, flavoring agents, coloring agents, preservatives, antioxidants and the like suitable for human consumption.

Typically, when used in a package such as a pouch, the multilayer polymeric sheet will involve at least three categorical layers, including but not limited to, an outermost structural or abuse layer, an inner barrier layer, and an innermost layer and optionally one or more adhesive or tie layers there between. Also, the innermost layer making contact with and compatible with the intended contents of the pouch is preferably capable of forming lock-up perimeter seals (i.e., seal strengths typically greater than 1,500 gram/inch) for containing the contents of the package. Most preferably the innermost layer is also heat-sealable.

The outermost structural, or abuse, layer can comprise oriented polyester, oriented polypropylene or oriented toughened nylon of the present invention. This layer preferably is reverse printable and advantageously unaffected by the sealing temperatures used to make the package, since the package is sealed through the entire thickness of the multilayer structure. The thickness of this layer is typically selected to control the stiffness of the package, and may range from about 10 to about 60 μm, preferably from about 10 to about 50 μm.

The inner layer can include one or more barrier layers, depending on which atmospheric conditions (oxygen, humidity, light, and the like) that potentially can affect the product inside the pouch. Barrier layers can be metallized polypropylene (PP) or polyethylene terephthalate (PET), ethylene vinyl alcohol (EVOH), aluminum foil, nylon, blends or composites of the same as well as related copolymers thereof. Barrier layer thickness will depend on the sensitivity of the product and the desired shelf life.

The innermost layer of the package is the sealant. The sealant is selected to have minimum effect on taste, color or stability of the contents, to be unaffected by the product, and to withstand sealing conditions (such as liquid droplets, grease, dust, or the like). The sealant is typically a resin that can be bonded to itself (sealed) at temperatures substantially below the melting temperature of the outermost layer so that the outermost layer's appearance will not be affected by the sealing process and will not stick to the jaws of the sealing bar. Typical sealants used in multilayer pouches include ethylene copolymers, such as low density polyethylene (LDPE), linear low density polyethylene (LLDPE), metallocene polyethylene (mPE), or copolymers of ethylene with vinyl acetate or methyl acrylate or copolymers of ethylene and acrylic (EM) or methacrylic acid (EMAA), optionally ionomerized (i.e., partially neutralized with metal ions such as Na, Zn, Mg, or Li). Typical sealants can also include polypropylene copolymers. Sealant layers are typically 25 to 100 μm thick.

Pouches of this invention can be prepared by providing a continuous web of packaging film in which the film is oriented in a U- or V-shaped trough. A stand-up pouch of the present invention can be prepared by providing a continuous web of packaging film in which the film comprises a gusset or pleat to provide a W-shaped trough.

The continuous web of packaging film used to prepare a flexible pouch useful in this invention may comprise a single sheet of film that is oriented into a trough as described above. Alternatively, the web may comprise two or three sheets of packaging film that are bonded together by, for example, heat sealing seam(s) at the bottom of the trough. In this alternative, the sheets may be the same or different. A particular form of stand-up pouch comprises three sheets of packaging film, one of which forms the bottom of the pouch and is pleated, and two that form the sides of the pouch. The sheets are joined together by two seams at the bottom of the trough. The seams provide sufficient rigidity to the pouch to enable it to stand upright.

The trough-shaped web is divided into receptacles the size of individual pouches by transverse seals prepared typically by means of heat sealing. Pouches may optionally comprise fitments to enable access to the contents of the pouch after filling. The fitment is inserted between the margins of the film web, and a top seal of the pouch is made by sealing the fitment to the margins of the web and sealing the margins to each other. The individual pouches are cut from the web by means of transverse cutters. The operations of forming, filling and sealing the pouch can be prepared by performing the steps described above concurrently and/or sequentially.

In a particular embodiment, the pouch may be prepared, a fitment inserted and the pouch subsequently filled. The “preformed” pouch of this embodiment is prepared generally as described above, in which flexible packaging film(s) are formed into a pouch shape and the fitment inserted between the ends of the film(s) and joined to the film(s), for example by heat sealing. In this embodiment, portions of the film margins are not sealed together, providing an opening for subsequent filling of the pouch. For example, the fitment is inserted and joined to the pouch at the junction of a transverse seal and the open end of the pouch, and the remainder of the open end is left unsealed. The pouch may also be shaped so that the fitment is inserted and sealed in a diagonal corner of the open end of the pouch. Pouches prepared in this embodiment can be collected and transported to a separate filling operation to be filled with contents. In the filling operation, the desired amount of the contents of the pouch is placed into the pouch through the opening, typically by means of a metering valve. The opening is sealed by joining the margins of the film(s) that form the opening (for example, by heat sealing) to form a top seal.

Pouch making equipment such as that made by Totani Corporation, Kyoto, Japan or Klockner Barlelt Co., Gordonsville, Va. can be advantageously used practicing this invention.

Bottles of this invention can be prepared by using standard blow molding equipment such as the ones produced by Bekum, Sig etc. It is particularly suitable to have the bottles produced on Weiler or Rommelag blow form filled (BFF) machine under sterile environment. The bottles of the present invention can be either single layer or multilayer structures comprising at least one layer of the present invention.

Another article of this invention is a profile. Profiles are defined by having a particular shape and by their process of manufacture known as profile extrusion. Profiles are not film or sheeting, and thus the process for making profiles does not include the use of calendering or chill rolls. Profiles are also not prepared by injection molding processes. Profiles are fabricated by melt extrusion processes that begin by extruding a thermoplastic melt through an orifice of a die forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. With extremely complex shapes, support means are often used to assist in shape retention.

A common shape of a profile is tubing. Tubing assemblies for the transport of liquids and vapors are well known in the art. Tubing is used for fluid transfer in medical applications or in transferring fluids such as beverages. These applications require good moisture barrier properties, chemical resistance, toughness and flexibility. Clarity of the tubing can be important for visual observation of the fluids being transferred. Furthermore, depending on the use of the tubing, there may be exposure to extremely low temperatures and/or extremely high temperatures. The compositions as described herein provide a good combination of toughness, flexibility and clarity, making them suitable for preparation of profiles such as tubing.

While the invention has been particularly shown and described with reference to the preferred embodiments thereof, it will be understood by those skilled in the art that various changes in form and details may be made without departing from the spirit and scope of the invention.

### EXAMPLES

The following Examples are merely illustrative, and are not to be construed as limiting the scope of the invention described and/or claimed herein.

Description of Processing and Testing of Materials:

Examples of thermoplastic compositions for producing a film or sheet of toughened transparent material of this invention comprise polyamides blended with neutralized ethylene acid copolymers with monocarboxylic and dicarboxylic acids as monomers. See Table 1 below for specific examples. Table 1 reports the properties of blends of a polyamide (i.e. nylon 6) and 20 weight % of modifiers selected from a conventional ionomer (Comparative Example C2), a maleated polymer (Comparative Example C3) and a neutralized ethylene acid copolymer with monocarboxylic and dicarboxylic acids as monomers, i.e. an anhydride ionomer (Example 1). Table 1 also reports the properties of a film comprising nonmodified nylon 6, prepared similarly to the Examples (Comparative Example C1). The polymers used in Table 1 are:

Polyamide-1: Nylon 6 available as Ultramid B3 (from BASF)

lonomer-1: a soft ionomer terpolymer comprising ethylene, 10 weight % of iso-butyl acrylate and 10 weight% of methacrylic acid wherein nominally 70% of the available carboxylic acid moieties are neutralized with zinc cations, having a Ml of 1.0 (E/1.0MAA/10i-BA/70Zn).

Graft-1: a maleic anhydride grafted ethylene/propylene rubber with a density of 0.87 and melt flow index of 23, measured at 280° C. with a 2.16 kg weight, available as Fusabond® 416D from DuPont.

Al-1: an anhydride ionomer terpolymer comprising ethylene, 13 weight % of acrylic acid and 4 weight % of maleic anhydride monoethylester wherein nominally 50% of the available carboxylic acid moieties are neutralized with zinc cations (E/13AA/4MAME/50Zn).

Testing methods used:

The tensile strength was measured using ASTM D882.

The transmittance haze was measured according to ASTM D1003.

Elmendorf Tear Strength was measured using ASTM D-1 922.

Spencer Impact Resistance was measured using ASTM 3420.

Pinhole flex test: The film sample is formed into an airtight tube and then alternatively flexed and relaxed axially until failure occurs and the tester automatically stops. Failure is indicated when a pinhole or series of pinholes occur which are greater in area than that of the air supply orifice, causing a pressure drop across the test system. The flexing action occurs at a stroke speed of 580 cycles/minute with a stroke length of 3.175 mm. This test enables the study of the ability of thin film to withstand repetitive folding and unfolding at one or more points. The test is useful in predicting the relative behavior of a series of films intended for applications in packaging or other uses where flexing motions may be encountered.

TABLE 1
Properties¹ of Modified Nylon 6 Blown Films

| | Modifier | Film Thickness | Pinhole Flex | Haze | Elmendorf Tear | Spencer Impact |
|---|---|---|---|---|---|---|
| Example | (20 wt %) | (mils) | (strokes) | (%) | (MD/TD) (grams/mil) | (inch. lb/mil) |
| Comparative Example C1 | none | 4.1 | 10,350 | 0.65 | 61/59 | 4.8 |
| Comparative Example C2 | Ionomer-1 | 4.5 | 44,400 | 24.8 | 76/80 | 6.1 |
| Comparative Example C3 | Graft-1 | 5 | 153,700 | 40.1 | 120/104 | 4.8 |
| Example 1 | Al-1 | 4.1 | 91,210 | 2.1 | 55/69 | 5.5 |

¹Properties determined at ambient temperature (approx. 25° C.).

As shown in Table 1, Example 1, nylon 6 modified with 20 weight % of anhydride ionomer Al-1, shows much improved pinhole flex resistance over the control nylon 6 film (Comparative Example 1) while retaining excellent optical clarity (low haze). Comparison of Example 1 to Comparative Example C2 shows that the anhydride ionomer also outperforms a conventional soft ionomer (lonomer-1) in modifying nylon 6, imparting both higher toughness and higher optical clarity, as indicated by higher flex (pinhole) resistance and the lower haze values. While a maleic anhydride graft copolymer imparts superior flex resistance, the film has an unacceptably high haze (Comparative Example C3).

The cast films reported in Table 2 were prepared by melt blending the polymeric components in a 28-mm twin-screw extruder equipped with a cast film drum. The films were kept dry after preparation until being tested in the dart impact test.

The polymers used in Table 2 are:

Polyamide-2: Nylon 6 available as Ultramid B35 (from BASF)

lonomer-2: a soft ionomer terpolymer comprising ethylene, 23 weight % of n-butyl acrylate and 9 weight% of methacrylic acid wherein nominally 50% of the available carboxylic acid moieties are neutralized with zinc cations, having a Ml of 0.6 (E/9MAA/23n-BA/50Zn).

Al-2: a terpolymer comprising ethylene, 11 weight % of methacrylic acid and 6 weight % of maleic anhydride monoethylester wherein nominally 60% of the available carboxylic acid moieties are neutralized with zinc cations (E/11 MAA/6MAME/60Zn).

lonomer-3: a copolymer comprising ethylene and 15 weight% of methacrylic acid wherein nominally 60% of the available carboxylic acid moieties are neutralized with zinc cations, having a Ml of 1.0 (E/15MAA/60Zn).

Graft-2: a MAH grafted ethylene-octene copolymer with a density of 0.87 g/cc and a melt flow index of 1.6 as measured according to ASTM Dl 238 (190 C, 2.16 kg), available as Fusabond®) 493D from DuPont.

The testing methods are:

Dart Impact Test: This test is a measure of impact and/or puncture resistance, according to ASTM D1709, tested at 10° F. (−12.2° C./) using a dart of 3.8-cm (1.5-inch) diameter dropped from a 66-cm (26-inch) height. The test employed varied dart masses to determine a dart mass that renders a 50% failure rate of film breakage of the tested film. For a given dart mass, 10 drop tests were conducted. Table 2 reports the dart mass in grams that rendered a 50% failure rate. At lower dart mass, the film may pass all of the ten drops, and at higher dart mass, the film may break in all of the ten drops.

TABLE 2
Properties of Modified Nylon 6 Films (Cast Film)

| | | Film | Dart Impact | |
|---|---|---|---|---|
| | | Thickness | Test, at 10° F. | |
| Example | Modifier (weight %) | (mils) | (Dart mass, grams) | |
| Comparative | None | 2 | <160 | g |
| Example C4 | | | | |
| Comparative | Ionomer-2 (30) | 2.5 | >580 | grams |
| Example C5 | | | | |
| Example 3 | Al-2 (30) | 2 | 280 | g |
| Example 4 | Ionomer-2/Al-2 (15/15) | 2.5 | 530 | g |
| Example 5 | Graft-2/Al-2 (15/15) | 3 | >580 | g |

As presented in Table 2, all the films modified with anhydride ionomer Al-2 or blends containing the anhydride ionomer show much-improved results in the dart impact test conducted at 10 ° F. compared to a nonmodified film. The nonmodified nylon 6 films (Comparative Example C4) performed poorly at 10° F. in the dart impact test. For example, nine out of ten drops broke under a dart mass of 160 grams dropped from a height of 26 inches. The Example 3 film, containing anhydride ionomer Al-2, showed improvement in the Dart impact test, and, by qualitative visual observation, the film had excellent optical clarity.

Comparative Example C5 containing soft ionomer lonomer-2 shows a superior dart impact resistance compared to the unmodified film. However, the film has undesirably higher haze. As shown in Example 4, a combination of anhydride ionomer with the soft ionomer retains significantly improved toughness over the nonmodified film while exhibiting improved optical clarity. Similarly, Example 5, a combination of anhydride ionomer and a soft modifier, such as soft maleated PE, provide both excellent dart impact resistance and good optical clarity (by visual observation).

What is claimed is:

1. A film obtained from a thermoplastic composition comprising:
(1) from about 65 to about 90 weight % of a polyamide; and
(2) from about 5 to about 35 weight % of a modifier comprising an ionomeric composition comprising a copolymer of
(a) ethylene;
(b) from about 5 weight % to about 15 weight % of an alpha, beta-unsaturated C₃-C₈ carboxylic acid;
(c) from about 0.5 weight % to about 12 weight % of at least one comonomer that is an ethylenically unsaturated dicarboxylic acid or derivative thereof selected from the group consisting of maleic acid, fumaric acid, itaconic acid, maleic anhydride, and a C₁-C₄ alkyl half ester of maleic acid; and
(d) from 0 weight % to about 30 weight % of monomers selected from alkyl acrylate and alkyl methacrylate, wherein the alkyl groups have from one to twelve carbon atoms;
wherein (i) the carboxylic acid functionalities present are at least partially neutralized by one or more alkali metal, transition metal, or alkaline earth metal cations, and (ii) the film held a temperature of less than −1° C. at least 50% of the time is capable of supporting a weight of at least about 165 grams dropped onto the film from a height of 66 cm above the film.

2. The film of claim 1 wherein said polyamide is selected from the group consisting of nylon 6; nylon 6,6; nylon 11; nylon 12; nylon 12,12; nylon 6/6,6; nylon 6,10; nylon 6,12; nylon 6,6/12; nylon 6/6,6/6,10 and nylon 6/6T.

3. The film of claim 2 wherein said polyamide is selected from the group consisting of nylon 6 and nylon 6,6.

4. The film of claim 3 wherein said polyamide is nylon 6.

5. The film of claim 1 wherein component (2)(c) is present in a range from 3 to 12 weight %.

6. The film of claim 5 wherein component (2)(c) is present in a range from 4 to 10 weight %.

7. The film of claim 6 wherein component (2)(c) is a C₁-C₄ alkyl half ester of maleic acid.

8. The film of claim 1 wherein the modifier of component (2) further comprises at least one additional thermoplastic polymer in an amount up to about 30 weight % of the total thermoplastic composition.

9. The film of claim 8 wherein the at least one additional polymer is an E/X/Y copolymer where E is ethylene, X is a C₃ to C₈ ethylenically unsaturated carboxylic acid, and Y is a comonomer selected from alkyl acrylate and alkyl methacrylate wherein the alkyl groups have from 1 to 8 carbon atoms, wherein X is present in a range from 2 to 30 weight % of the E/X/Y copolymer, and Y is present in a range from 0 to 40 weight % of the E/X/Y copolymer, wherein the carboxylic acid functionalities present are at least partially neutralized by one or more alkali metal, transition metal, or alkaline earth metal cations.

10. The film of claim 8 wherein the at least one additional polymer is selected from the group consisting of maleated polymers, copolyetheresters, copolyetheramides, elastomeric polyolefins, styrene diene block copolymers and thermoplastic polyurethanes.

11. The film of claim 10 wherein the at least one additional polymer is selected from the group consisting of maleated polyethylene, maleated polypropylene, maleated styrene-ethylene-butene-styrene triblock copolymer, maleated polybutadiene.

12. The film of claim 1 that is a multilayer film or sheet.

13. The film of claim 1 wherein the film is oriented by a process comprising the steps of:
(a) heating the film; (b) expanding the heated film in either or both the transverse and/or machine directions; and, (c) optionally annealing the film.

14. An article comprising a film of claim 1.

15. The article of claim 14 wherein the article is a pouch, bottle or bag.

16. The article of claim 14 wherein the article is tubing.

17. The article of claim 14 wherein the article is a package.

18. The package of claim 17 wherein the package is for containing meat.

19. The package of claim 17 wherein the package can maintain an internal pressure of up to 400 mm of Hg.

20. The package of claim 19 wherein the package is suitable for use as a medical solution pouch.

21. The article of claim 14 wherein the article is thermoformed.
